(19) United States
(12) Patent Application Publication
(10) Pub. No.: US 2007/0077109 A1
(43) Pub. Date: Apr. 5, 2007

(54) Media cassette and image forming apparatus having the same

(75) Inventor: Dong-su Nam, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electgronics Co., Ltd.

(21) Appl. No.: 11/498,174

(22) Filed: Aug. 3, 2006

(30) Foreign Application Priority Data
Oct. 4, 2005 (KR) 10-2005-0093073

(51) Int. Cl. B41J 13/10

(52) U.S. Cl. 400/629

(57) ABSTRACT

A media cassette and an image forming apparatus having the media cassette are provided. The media cassette includes a cassette frame for loading and discharging a printing medium and a separation preventing member disposed at an upper surface of the cassette frame for contacting a printing medium being discharged to the upper surface of the cassette frame to prevent the printing medium from being separated from the cassette frame.

### CROSS-REFERENCE TO RELATED PATENT APPLICATION

This application claims the benefit under 35 U.S.C. § 119(a) of Korean Patent Application No. 10-2005-0093073, filed on Oct. 4, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to a media cassette that prevents sliding of a printing medium and an image forming apparatus having the media cassette.

2. Description of the Related Art

Conventional image forming apparatuses may be roughly classified into three types according to the method of printing: electrophotographic, ink-jet, or thermal.

A thermal type image forming apparatus has a thermal print head (TPH). The TPH has a plurality of heating elements disposed in the width direction of a printing medium which are selectively heated. Examples of thermal type image forming apparatuses include a direct coloring image forming apparatus in which a colored printing medium is directly heated to form color image and a dye vaporizing image forming apparatus in which a ribbon coated with a dye is heated to vaporize the dye and form an image on the printing medium.

A small portable photo printer, which is a thermal type image forming apparatus, has a media cassette for loading a printing medium. The media cassette may be removed from the main frame of the printer. The media cassette may be designed so that the printing medium does not fall from the media cassette when carrying the media cassette.

FIG. 1 is a side view of an example of a conventional image forming apparatus, and FIG. 2 is a side view of another example of a conventional image forming apparatus.

Referring to FIGS. 1 and 2, each of the image forming apparatuses include a main frame 11 and a media cassette 13. The main frame has a printing unit (not shown) for forming an image onto a printing medium S. The media cassette 13 is disposed in the main frame 11 in a detachable manner and stores a plurality of printing mediums S.

The media cassette 13 stores the printing mediums S and also supports a printing medium S having an image formed thereon so that the printing medium S can be loaded on the upper surface of the media cassette 13. In other words, a sheet of printing medium S stored in the media cassette 13 is fed into the main frame 11 to form an image thereon, is discharged by a discharging roller 12, and is then loaded on the upper surface of the media cassette 13.

The front end portion of the media cassette 13 is inserted into the main frame 11 when placing the media cassette 13 in the main frame 11. Thus, the exposed length L1 of the media cassette 13 that is exposed out from the main frame 11 is less than the length of the actual media cassette 13 by the length that is inserted into the main frame 11.

In this case, the printing medium S is loaded outside of the media cassette 13. To prevent this, the exposed length L1 of the media cassette 13 has to be greater than the length L of the printing medium S.

To this end, the media cassette 13 may have a double-structure using a hinge 13, or the exposed length L1 of the media cassette 23 may be greater than the length L of the printing medium S, as shown in FIG. 2.

However, if the length of the media cassette is greater than the length of the printing medium S, the manufacturing cost of the media cassette increases. In addition, the size of the media cassette increases, which makes it difficult to place and use the image forming apparatus.

Accordingly, there is a need for an improved media cassette for loading a printing medium, and an image forming apparatus having the same.

### SUMMARY OF THE INVENTION

An aspect of the present invention is to address at least the above problems and/or disadvantages and to provide at least the advantages described below. Accordingly, an aspect of the present invention is to provide a media cassette for stably loading a printing medium without sliding and an image forming apparatus having the media cassette.

According to an aspect of the present invention, a media cassette for an image forming apparatus comprises a cassette frame for loading and discharging a printing medium and a separation preventing member disposed at an upper surface of the cassette frame for contacting a printing medium being discharged to the upper surface of the cassette frame to prevent the printing medium from being separated from the cassette frame.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a side view of an example of a conventional image forming apparatus;

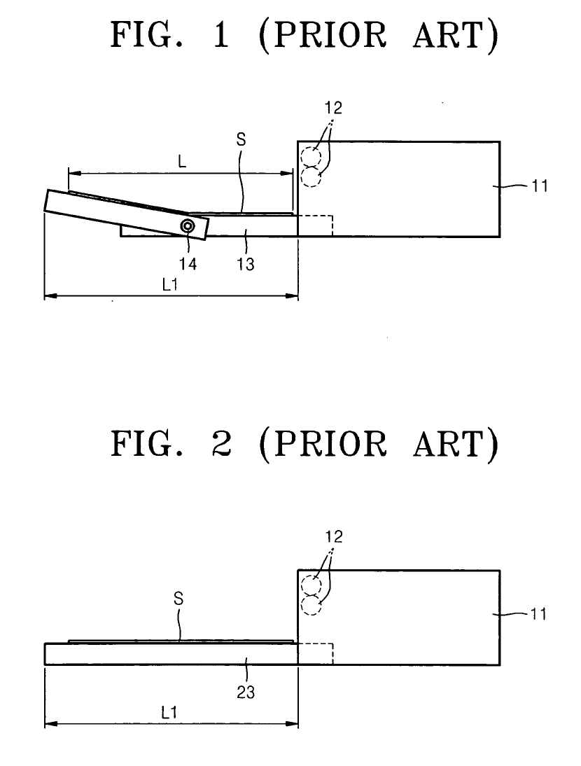

FIG. 2 is a side view of another example of a conventional image forming apparatus;

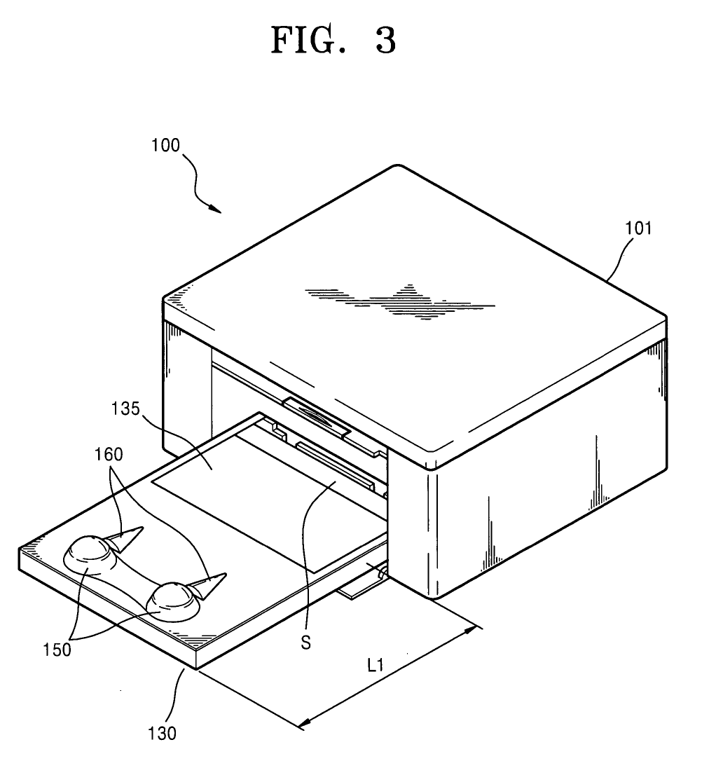

FIG. 3 is a perspective view of an image forming apparatus using a separation preventing member according to an exemplary embodiment of the present invention;

FIG. 4 is a cross-sectional view of the image forming apparatus of FIG. 3;

FIG. 5 is a perspective view of a media cassette of FIG. 4; and

FIGS. 6A to 6D are views showing the operation of the separation preventing member of the image forming apparatus of FIG. 3.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention and are merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

Hereinafter, exemplary embodiments of the present invention will be described in detail with reference to the accompanying drawings.

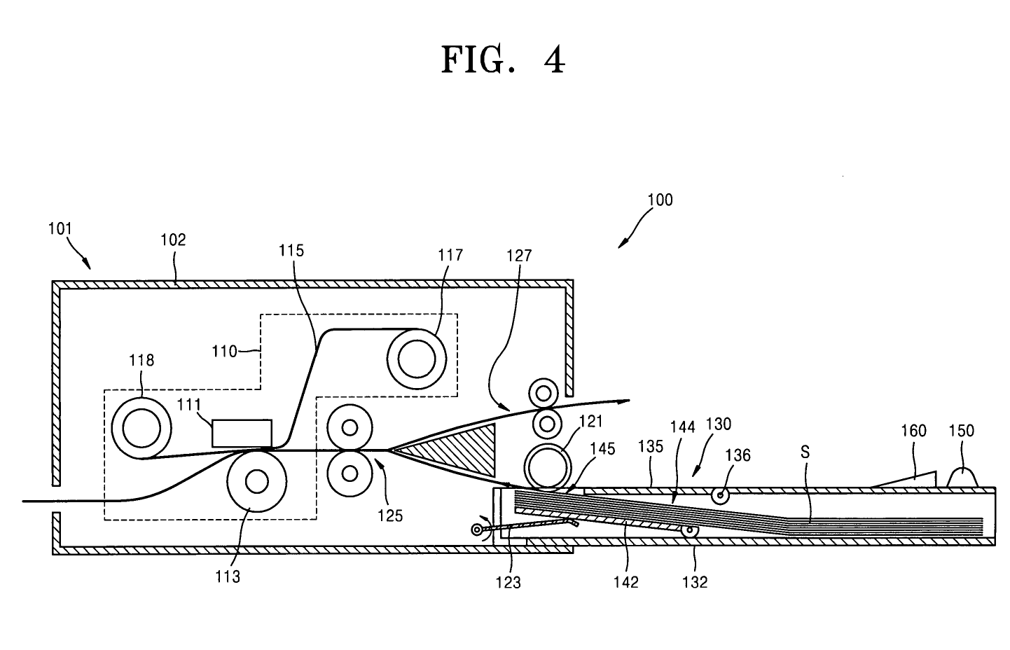

Referring to FIGS. 3 to 5, an image forming apparatus 100 includes a main frame 101 having a printer engine 110 for printing an image onto a printing medium S and a media cassette 130 placed in the main frame 101 in a detachable manner.

The printer engine 110 is disposed in a case 102 forming an enclosure of the main frame 101. The printer engine 110 includes an ink ribbon 115 coated with a dye for coloring the printing medium S and a thermal print head (TPH) 111 which applies heat on the ink ribbon 115 so that the dye is coated on the printing medium S to color the printing medium S.

A plurality of heating elements (not shown) are disposed in the TPH 111 in the width direction of the printing medium S, and parts of the heating elements are selectively heated to color the printing medium S as mentioned above. To maintain tension on the ink ribbon 15, the ink ribbon 115 is wound around a pair of ribbon support wheels 117 and 118. A platen roller 113 for pressing the printing medium S and the ink ribbon 115 towards the heating elements (not shown) of the TPH 111 is disposed under the TPH 111.

In addition, the main frame 101 includes a pick-up roller 121, feeding rollers 125, and discharging rollers 127. The pick-up roller 121 picks up the printing medium S loaded on the media cassette 130 sheet by sheet. The feeding rollers 125 feed the picked up printing medium S between the TPH 111 and the platen roller 113 and then reversely feed the printing medium S during the coloring process. The discharging rollers 127 discharge the printing medium S out of the main frame 101 of the image forming apparatus 100. The feeding rollers 125 and the discharging rollers 127 are composed of a pair of rollers facing each other. One roller of the pair is a driving roller and the other roller is an idle roller that rotates along with the driving roller.

The process of forming an image with the image forming apparatus 100 will now be described in detail.

The printing medium S loaded on the media cassette 130 is picked up by the pick-up roller 121 and then is fed between the TPH 111 and the platen roller 113, which are separated from each other, by the feeding roller 125. When a rear end portion of the printing medium S reaches the feeding rollers 125, the feeding rollers 125 stop rotating. Then, the TPH 111 moves toward the platen roller 113, with the ink ribbon 115 and the printing medium S being disposed between the platen roller 113 and the TPH 111.

The feeding rollers 125 reversely rotate with respect to the feeding direction and pull the printing medium S disposed between the TPH 111 and the platen roller 113 towards the discharging rollers 127.

The ink ribbon 115 travels at a feeding speed of the printing medium, and the heating elements (not shown) of the TPH 111 are selectively heated to vaporize the dye coated on the ink ribbon 115 to color the printing medium S, thereby forming an image on the printing medium S. The printing medium S having an image formed thereon is discharged out of the main frame 101 by the discharging rollers 127.

The media cassette 130 includes a cassette frame 131 which includes a base frame 132 and a cover 135 connected with the base frame 132 by a hinge 136. A cavity 144 for loading the printing medium S is provided in the base frame 132. A tray 142 is disposed in the cavity 144 in a manner such that the tray 142 can be raised a predetermined distance, and the front end portion of the printing medium S loaded in the cavity 144 is supported by the tray 142.

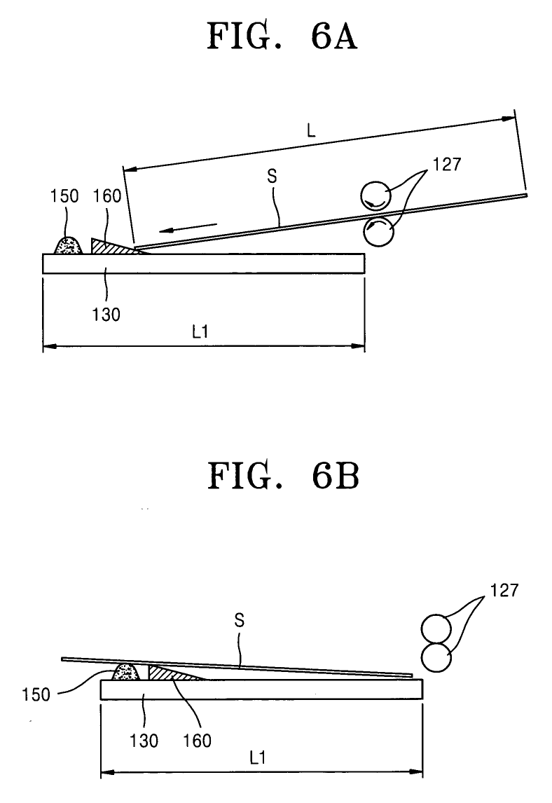

The cover 135 covers an open upper side of the base frame 132. When the cover 135 is open, an aperture 145 on the upper side of the base frame 132 is enlarged, so that the printing medium S can be easily loaded in the cavity 144. As shown by phantom lines in FIG. 5, when the cover 135 is closed, the aperture 145 becomes smaller such that only the front end portion of the printing medium S can be exposed, thereby preventing contamination of the printing medium S by external factors.

A separation preventing member 150 is disposed at the upper side of the base frame 132. The separation preventing member 150 prevents a printing medium S disposed on the upper side of the base frame 132 from being separated from the upper side of the base frame 132 when the next printing medium S discharged of the main frame 101 by the discharging rollers 127 contacts the printing medium S.

The separation preventing member 150 is disposed at the rear end portion of the base frame 132 and protrudes from the upper side of the base frame 132. Preferably, the separation preventing member 150 is made of silicon rubber having a friction coefficient of 0.3 or more. The separation preventing member 150 contacts the lower surface of the printing medium S and obstructs feeding of the printing medium S using friction forces. The separation preventing member 150 is not limited to the shape in the drawings, and may have other shapes. The separation preventing member 150 is preferably symmetrical with respect to the center line of the printing medium S in the longitudinal direction, so that the feeding printing medium S does not rotate due to an eccentric force when the printing medium S contacts the separation preventing member 150.

A guide portion 160 for guiding the printing medium S towards the upper side of the separation preventing member 150 is provided in front of the separation preventing member 150 with respect to a feeding direction of the printing medium S. If the guide portion 160 is not provided, feeding of the printing medium S is obstructed when the printing medium S contacts the lower side of the separation preventing member 150. To prevent this, the guide portion 160 is provided so that the printing medium S can be guided to the upper side of the separation preventing member 150.

A pick-up plate 123, which presses the tray 142 towards the aperture 145 when the media cassette 130 is placed in the main frame 101, is provided under the pick-up roller 121 of the main frame 101. A hole-shaped pick-up plate entrance portion 133 is provided at the front end portion of the base frame 132, so that the pick-up plate 123 can be inserted under the tray 142 when the media cassette 130 is placed on the main frame 101.

The process of feeding and discharging the printing medium S will now be described.

When the media cassette 130 on which the printing medium S is loaded is placed in the main frame 101, the pick-up plate 123 enters through the pick-up plate entrance portion 133 provided at the front end portion of the base frame 132 and is placed under the tray 142. The pick-up roller 121 is disposed over the aperture 145 on the upper side of the base frame 132.

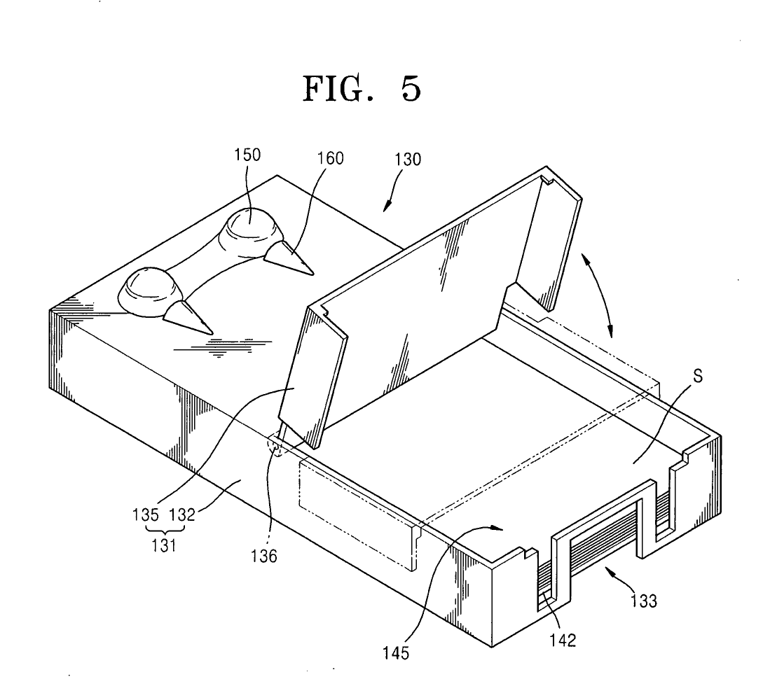

When starting printing, the pick-up roller 121 rotates and the pick-up plate 123 concurrently rotates in the direction of the arrow in FIG. 4 to press the tray 142 so that the tray 142 is raised. By this operation, the front end portion of the printing medium S loaded on the base frame 132 is pressed towards the aperture 145 and the pick-up roller 121, and a sheet of printing medium S to be printed is picked up by friction forces between the pick-up roller 121 and the printing medium S and enters into the main frame 101.

When the printing medium S to be printed is fed to the main frame 101, the pick-up plate 123 reversely rotates with respect to the direction of the arrow in FIG. 4 to prevent another printing medium S from being picked-up. The pick-up plate 123 does not rotate again in the direction of the arrow until the first fed printing medium S having an image formed thereon is discharged out of the main frame 101.

The printing medium S having an image formed thereon by the printer engine 110 is discharged out of the main frame 101 through the discharging rollers 127.

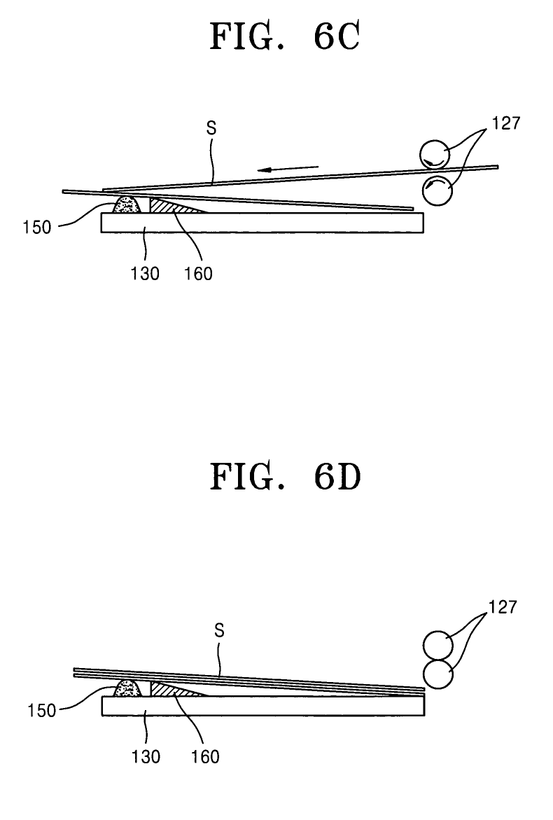

Referring to FIGS. 6A to 6D, the front end portion of the printing medium S passing through the discharging rollers 127 contacts the upper side of the base frame 132 and is fed in the direction of the arrow.

The printing medium S moves along with the guide portion 160, contacts the upper side of the separation preventing member 150, and continues being fed. When the printing medium S contacts the separation preventing member 150, the feeding of the printing medium S becomes slower due to friction forces between the printing medium S and the separation preventing member 150.

Even after the rear end portion of the printing medium S passes through the discharging rollers 127 and is discharged out of the main frame 101, the front end portion of the printing medium S contacts the separation preventing member 150 and is placed on the base frame 132 due to friction forces between the printing medium S and the separation preventing member 150.

Even if two sheets of printing mediums S contact each other as the next sheet of printing medium S is discharged, the friction forces between the printing medium S and the separation preventing member 150 are greater than the friction forces between the two sheets of printing mediums S. Therefore, the sheet of printing medium S located beneath the sheet of printing medium S being discharged does not move even after the two sheets of printing mediums S contact each other, and the next sheet of printing medium S is thereby loaded.

An exposed length L1 of the main frame 101 is less than a length L of the printing medium S, however, when the media cassette 130 is placed in the main frame 101, the printing medium S can be loaded on the upper side of the media cassette 130 by the separation preventing member 150.

Accordingly, a media cassette of the present invention can prevent the separation of a printing medium from the media cassette, and the size and cost can be reduced by making the exposed length of the media cassette less than the length of the printing medium.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A media cassette comprising:
a cassette frame for loading and discharging a printing medium; and
a separation preventing member disposed at an upper surface of the cassette frame for contacting a printing medium being discharged to the upper surface of the cassette frame to prevent the printing medium from being separated from the cassette frame.

2. The media cassette according to claim 1, wherein the separation preventing member protrudes from the upper surface of the cassette frame.

3. The media cassette according to claim 1, wherein the separation preventing member is disposed at a rear end portion of the cassette frame.

4. The media cassette according to claim 1, wherein the separation preventing member has a friction coefficient of 0.3 or more.

5. The media cassette according to claim 1, further comprising a guide portion for guiding the discharging printing medium towards an upper side of the separation preventing member.

6. The media cassette according to claim 1, wherein the separation preventing member is symmetrical with respect to a longitudinal center line of the printing medium.

7. An image forming apparatus having a main frame, a printer engine for printing an image onto an printing medium, and a media cassette which loads printing media, supports discharging printing a media on which an image is formed, and is disposed in the main frame of the image forming apparatus in a detachable manner, wherein the media cassette comprises:
a cassette frame for loading and discharging a printing medium; and
a separation preventing member disposed at an upper surface of the cassette frame for contacting a printing medium being discharged to the upper surface of the cassette frame to prevent the printing medium from being separated from the cassette frame.

8. The image forming apparatus according to claim 7, wherein the separation preventing member protrudes from the upper surface of the cassette frame.

9. The image forming apparatus according to claim 7, wherein the separation preventing member is disposed at a rear end portion of the cassette frame.

10. The image forming apparatus according to claim 7, wherein the separation preventing member has a friction coefficient of 0.3 or more.

11. The image forming apparatus according to claim 7, further comprising a guide portion for guiding the discharging printing medium towards an upper side of the separation preventing member.

12. The image forming apparatus according to claim 7, wherein the separation preventing member is symmetrical with respect to a longitudinal center line of the printing medium.

13. A media cassette comprising:
a cassette frame for feeding a printing medium to an image forming apparatus, the cassette frame having an upper surface for receiving a printing medium being discharged from the image forming apparatus; and
means for preventing a printing medium being discharged to the upper surface of the cassette frame from separating from the cassette frame.

14. The media cassette according to claim 13, wherein the preventing means comprises a separation preventing member disposed at an upper surface of the cassette frame for contacting the printing medium.

15. The media cassette according to claim 14, wherein the separation preventing member comprises a protrusion disposed on the upper surface of the cassette frame.

16. The media cassette according to claim 15, wherein the protrusion is disposed at a rear end portion of the cassette frame.

17. The media cassette according to claim 14, wherein the separation preventing member has a friction coefficient of 0.3 or more.

18. The media cassette according to claim 13, further comprising means for guiding the printing medium being discharged towards the upper side of the preventing means.

19. The media cassette according to claim 18, wherein the guiding means is disposed on the upper surface of the cassette frame.

20. The media cassette according to claim 13, wherein the preventing means is symmetrical with respect to a longitudinal center line of the printing medium.
